(19) United States
(12) Patent Application Publication
(10) Pub. No.: US 2026/0142415 A1
(43) Pub. Date: May 21, 2026

(54) Connector

(71) Applicant: Yazaki Corporation, Tokyo (JP)

(72) Inventors: Satoki Masuda, Makinohara-shi (JP); Ayumu Ishikawa, Fujieda-shi (JP); Tomoharu Suzuki, Fujieda-shi (JP); Toshikazu Yoshioka, Makinohara-shi (JP)

(21) Appl. No.: 19/393,849

(22) Filed: Nov. 19, 2025

(30) Foreign Application Priority Data
Nov. 20, 2024 (JP) 2024-202200

(51) Int. Cl. H01R 13/629; H01R 13/46

(52) U.S. Cl. CPC H01R 13/62977; H01R 13/46

(57) ABSTRACT

A connector includes: a female housing into which a mating connector is inserted; and terminal forming portions which are held by the housing. A first end side of the terminal forming portions is located on a side to which the mating connector is inserted, and constitutes a first terminal row in which connector terminals are arranged in a first direction. A second end side of the terminal forming portions is located on a side different from a side of the housing on which the first terminal row is provided, and constitutes a second terminal row in which connection terminals are arranged in a second direction. The first direction and the second direction are in a positional relationship of intersecting with each other in plan view with respect to a plane parallel to the first direction and the second direction.

### BACKGROUND OF THE INVENTION

### Field of the Invention

Aspects of the present invention relate to a connector.

Priority is claimed on Japanese Patent Application No. 2024-202200 filed in Japan on Nov. 20, 2024, the content of which is incorporated herein by reference.

### Description of Related Art

Conventionally, there is a lever-lock type connector structure in which fitting between a device-side connector and a wire harness (W/H)-side connector is performed by rotation of a lever (for example, see Patent Document 1 below).

### PRIOR ART DOCUMENT

### Patent Document

Patent Document 1: Japanese Unexamined Patent Application, First Publication No. 2018-206737

### SUMMARY OF THE INVENTION

Incidentally, in the case of the lever-lock type connector structure, when the device-side connector and the W/H-side connector are fitted to each other, the arrangement direction of a terminal row provided in the device-side connector and the arrangement direction of a terminal row provided in the W/H-side connector are in a positional relationship of being arranged in the same direction.

Therefore, the lever-lock type connector structure is limited to a straight type or an L type connector. In addition, the arrangement direction of wire cords pulled out from the W/H-side connector is also limited to the same positional relationship as the arrangement directions of the terminal rows.

An aspect of the present invention provides a connector capable of increasing the degrees of freedom in arrangement directions of terminal rows.

A connector according to one aspect of the present invention includes: a female housing into which a mating connector is inserted; and a plurality of terminal forming portions which are held by the housing. A first end side of the plurality of terminal forming portions is located on a side of the housing into which the mating connector is inserted, and constitutes a first terminal row in which a plurality of connector terminals are arranged in a first direction. A second end side of the plurality of terminal forming portions is located on a side different from a side of the housing on which the first terminal row is provided, and constitutes a second terminal row in which a plurality of connection terminals are arranged in a second direction. The first direction and the second direction are in a positional relationship of intersecting with each other in plan view with respect to a plane parallel to the first direction and the second direction.

A connector according to one aspect of the present invention includes: a male housing to be inserted into a mating connector; and a plurality of terminal forming portions which are held by the housing. A first end side of the plurality of terminal forming portions is located on a side of the housing to be inserted into the mating connector, and constitutes a third terminal row in which a plurality of connector terminals are arranged in a second direction. A second end side of the plurality of terminal forming portions is located on a side different from a side of the housing on which the third terminal row is provided, and constitutes a fourth terminal row in which a plurality of connection terminals are arranged in a first direction. The first direction and the second direction are in a positional relationship of intersecting with each other in plan view with respect to a plane parallel to the first direction and the second direction.

In the connector according to the aspect of the present invention, it is possible to increase the degrees of freedom in arrangement directions of terminal rows.

### BRIEF DESCRIPTION OF THE DRAWINGS

FIG. 1 is a perspective view illustrating a state where a device-side connector and a mating W/H-side connector according to a first embodiment of the present invention are fitted to each other.

FIG. 2 is a perspective view illustrating a state before the device-side connector and the W/H-side connector illustrated in FIG. 1 are fitted to each other.

FIG. 3 is a perspective view illustrating a constitution of the device-side connector illustrated in FIG. 1.

FIG. 4 is an exploded perspective view illustrating the constitution of the device-side connector illustrated in FIG. 1.

FIG. 5 is a perspective view illustrating a constitution of a W/H-side connector illustrated in FIG. 1.

FIG. 6 is an exploded perspective view illustrating the constitution of the W/H-side connector illustrated in FIG. 1.

FIG. 7 is a rear view of the device-side connector illustrated in FIG. 1.

FIGS. 8A and 8B are schematic diagrams illustrating modifications of arrangement directions of a first terminal row and a second terminal row of the device-side connector illustrated in FIG. 1.

FIG. 9 is a perspective view of a state where the W/H-side connector and a mating device-side connector according to a second embodiment of the present invention are fitted to each other as viewed from a rear side.

FIG. 10 is a perspective view of a state where the device-side connector and the W/H-side connector illustrated in FIG. 9 are fitted to each other as viewed from a front side.

FIG. 11 is a perspective view illustrating a state before the device-side connector and the W/H-side connector illustrated in FIG. 9 are fitted to each other.

FIG. 12 is a perspective view illustrating a constitution of the device-side connector illustrated in FIG. 9.

FIG. 13 is an exploded perspective view illustrating the constitution of the device-side connector illustrated in FIG. 9.

FIG. 14 is a perspective view illustrating a constitution of the W/H-side connector illustrated in FIG. 9.

FIG. 15 is an exploded perspective view illustrating the constitution of the W/H-side connector illustrated in FIG. 9.

FIG. 16 is a front view of the W/H-side connector illustrated in FIG. 9.

### DETAILED DESCRIPTION OF THE INVENTION

### FIRST EMBODIMENT

### Connector Structure

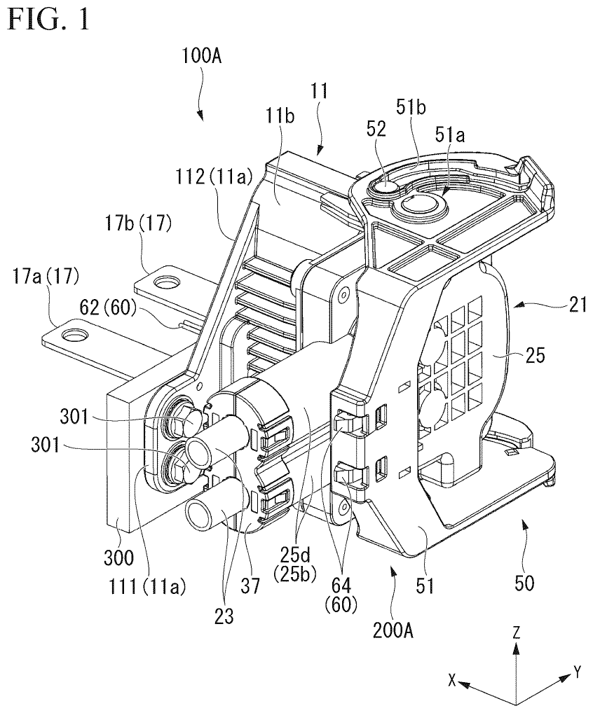

As a first embodiment of the present invention, for example, a connector structure of a device-side connector 100A and a mating W/H-side connector 200A according to the present embodiment illustrated in FIGS. 1 to 8B will be described.

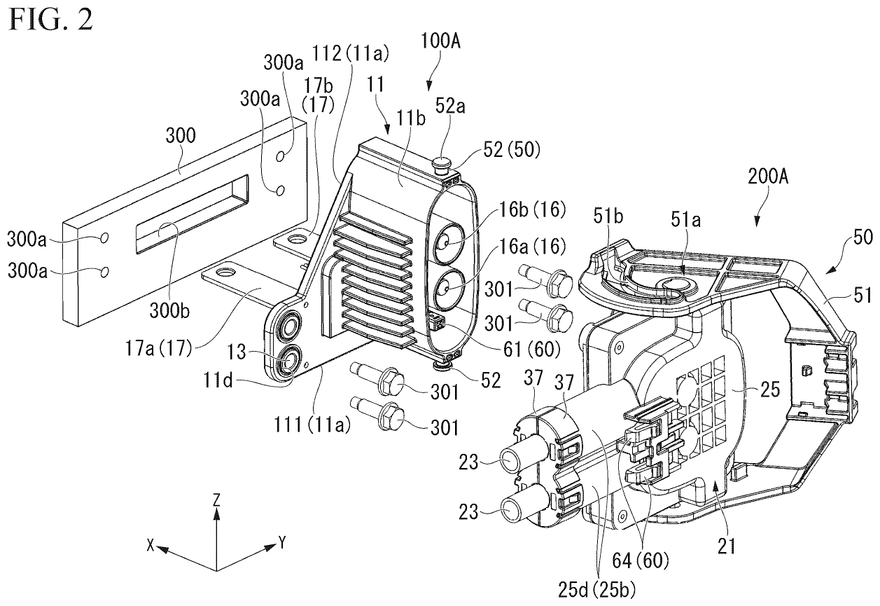

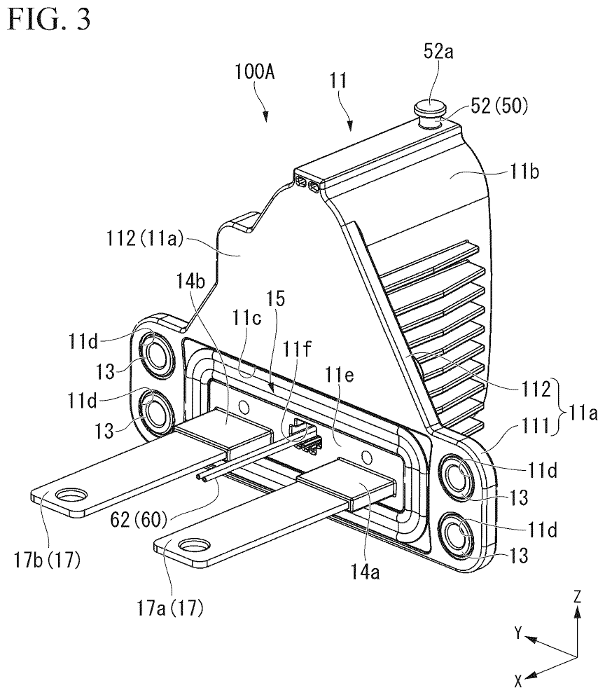

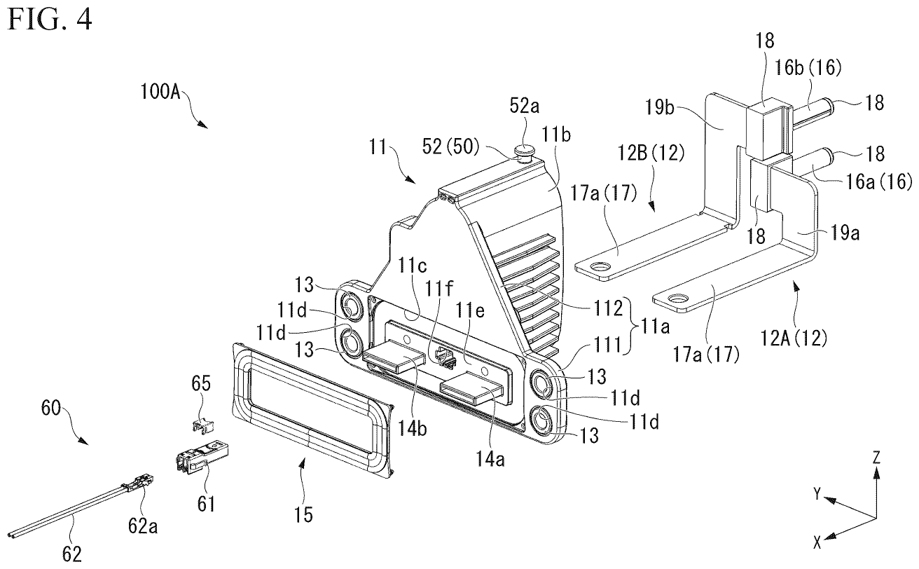

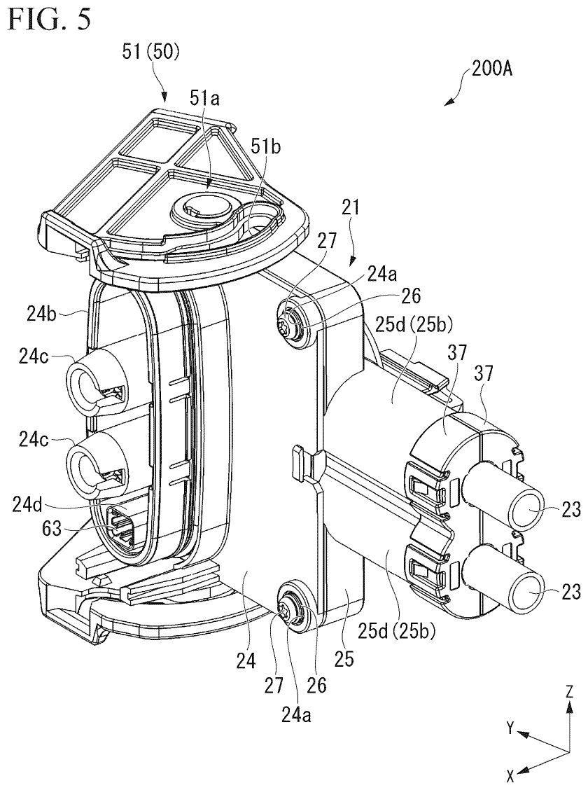

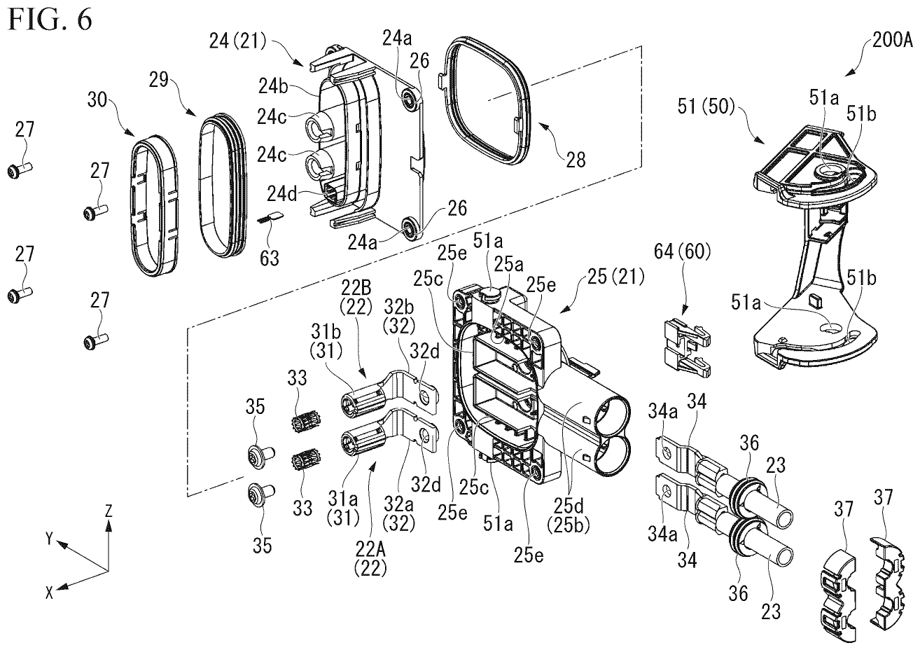

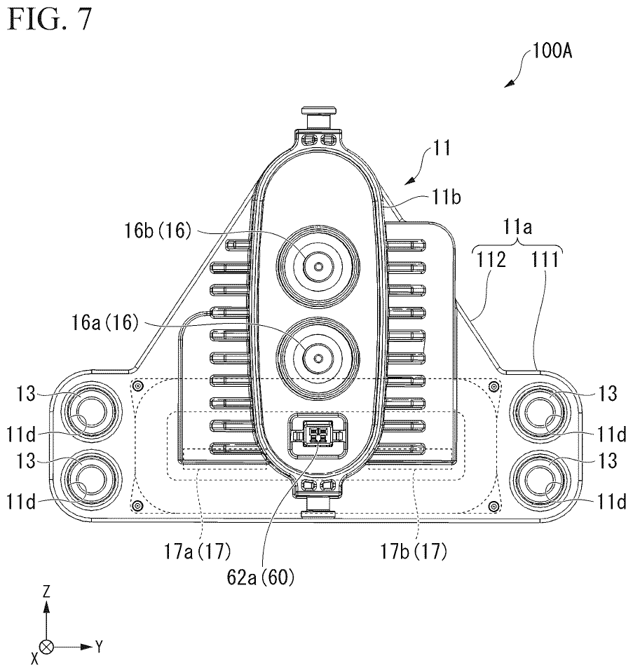

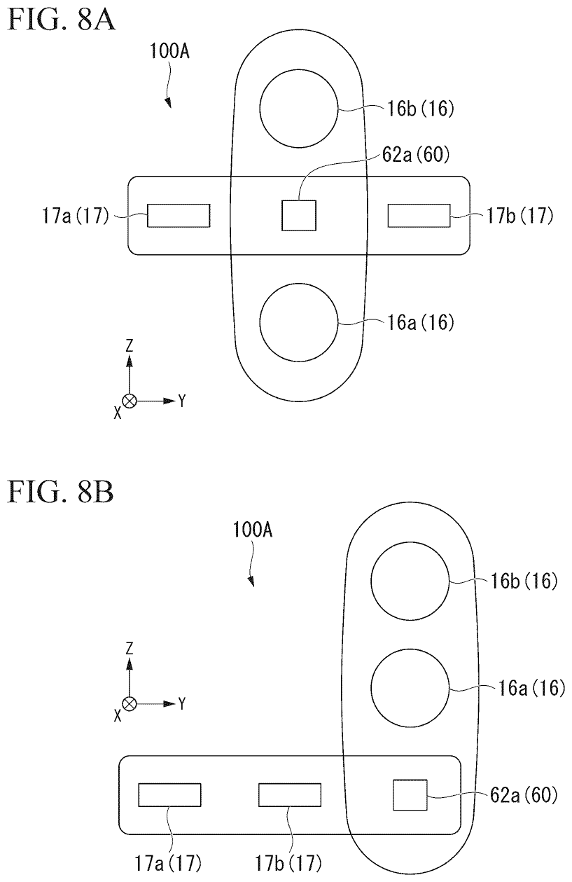

Note that FIG. 1 is a perspective view illustrating a state where the device-side connector 100A and the W/H-side connector 200A are fitted to each other. FIG. 2 is a perspective view illustrating a state before the device-side connector 100A and the W/H-side connector 200A are fitted to each other. FIG. 3 is a perspective view illustrating a constitution of the device-side connector 100A. FIG. 4 is an exploded perspective view illustrating the constitution of the device-side connector 100A. FIG. 5 is a perspective view illustrating a constitution of the W/H-side connector 200A. FIG. 6 is an exploded perspective view illustrating the constitution of the W/H-side connector 200A. FIG. 7 is a rear view of the device-side connector 100A. FIGS. 8A and 8B are schematic diagrams illustrating modifications of arrangement directions of a first terminal row and a second terminal row of the device-side connector 100A.

In addition, in the following drawings, an XYZ orthogonal coordinate system is set, and an X-axis direction is indicated as a front-rear direction (length direction) of the connectors 100A and 200A, a Y-axis direction is indicated as a left-right direction (width direction) of the connectors 100A and 200A, and a Z-axis direction is indicated as an up-down direction (height direction) of the connectors 100A and 200A.

As illustrated in FIGS. 1 and 2, the connector structure of the present embodiment electrically connects the device-side connector 100A and the mating W/H-side connector 200A of the present embodiment by fitting of the device-side connector 100A and the mating W/H-side connector 200A, and enables energization between the connectors 100A and 200A.

The device-side connector 100A of the present embodiment constitutes a female (receptacle)-side connector. On the other hand, the mating W/H-side connector 200A constitutes a male (plug)-side connector. Therefore, the connector structure of the present embodiment has a structure in which the device-side connector 100A and the W/H-side connector 200A are fitted by inserting the W/H-side connector 200A into the device-side connector 100A.

Note that in the present embodiment, one direction in which the W/H-side connector 200A is inserted into the device-side connector 100A is defined as a front (+X direction) of each of the connectors 100A and 200A, a direction opposite thereto is defined as a rear (−X direction), a side facing the one direction is defined as a front side of each of the connectors 100A and 200A, and a side opposite thereto is defined as a rear side of each of the connectors 100A and 200A.

### Device-Side Connector

As illustrated in FIGS. 1 to 4, the device-side connector 100A of the present embodiment includes a female housing 11 into which the W/H-side connector 200A is inserted, and a plurality of (two in the present embodiment) terminal forming portions 12 held by the housing 11.

The housing 11 is formed of a synthetic resin molded body. The housing 11 has a front wall 11a constituting a front side thereof and a fitting tubular portion 11b constituting a rear side thereof. The housing 11 has a structure in which the front wall 11a and the fitting tubular portion 11b are integrated with each other in a state where the plurality of terminal forming portions 12 are sandwiched between the front wall 11a and the fitting tubular portion 11b.

The front wall 11a is a portion that abuts against a unit 300 on a device side. The front wall 11a has a shape in which a lower plate portion 111 having a substantially rectangular flat plate shape with rounded corner portions and an upper plate portion 112 having a substantially triangular flat plate shape with rounded top portions are integrated in the up-down direction. In addition, the longitudinal direction of the lower plate portion 111 coincides with the width direction of the housing 11.

A substantially rectangular opening 11c is provided at the center of the lower plate portion 111 in the width direction. Two upper and lower holes 11d are provided on both sides in the width direction of the lower plate portion 111 with an opening 11c interposed therebetween, so as to penetrate in the front-rear direction. A circular ring-shaped collar 13 is fitted inside each hole 11d.

In the device-side connector 100A of the present embodiment, the housing 11 can be fixed to the unit 300 side by screwing a screw 301 into a screw hole 300a provided on the unit 300 side through each hole 11d.

The fitting tubular portion 11b is a portion into which a housing 21 of the W/H-side connector 200A described later is inserted. The fitting tubular portion 11b protrudes in a substantially elongated cylindrical shape rearward from the rear side of the front wall 11a, and opens in a substantially elongated circular shape on the rear side of the housing 11. In addition, the longitudinal direction of the fitting tubular portion 11b coincides with the up-down direction of the housing 11.

In addition, a fitting protrusion 11e having a shape corresponding to the opening 11c of the front wall 11a and fitted inside the opening 11c is provided on the front side of the fitting tubular portion 11b. Furthermore, on the front side of the fitting protrusion 11e, a plurality of (two in the present embodiment) sleeve portions 14a and 14b protruding forward from both sides in the left-right direction in a flat tubular shape are provided.

A unit packing 15 for waterproofing is provided on the front side of the front wall 11a. The unit packing 15 is fitted inside the opening 11c so as to surround the periphery of the plurality of sleeve portions 14a and 14b.

The plurality of terminal forming portions 12 are formed by processing a highly conductive metal plate such as copper into a predetermined shape. In the present embodiment, a bus bar obtained by bending a long metal plate is used as the terminal forming portion 12.

A first end side of the plurality of terminal forming portions 12 is located on a side (a rear side in the present embodiment) of the housing 11 to which the W/H-side connector 200A is inserted, and constitutes a first terminal row 16 in which a plurality of (two in the present embodiment) connector terminals 16a and 16b are arranged in a first direction (the up-down direction in the present embodiment) (hereinafter, referred to as a “first direction Z”).

A second end side of the plurality of terminal forming portions 12 is located on a side (a front side in the present embodiment) different from the side of the housing 11 on which the first terminal row 16 is provided, and constitutes a second terminal row 17 in which a plurality of (two in the present embodiment) connection terminals 17a and 17b are arranged in a second direction (the left-right direction in the present embodiment) (hereinafter, referred to as a “second direction Y”).

The plurality of connector terminals 16a and 16b constituting the first terminal row 16 are provided to protrude rearward in parallel to each other in a cylindrical shape in a state of being located inside the fitting tubular portion 11b. In addition, each of the connector terminals 16a and 16b is integrally provided with a resin cap 18 that covers the outside on a base end side and penetrates the inside from the base end side toward a tip end side.

The plurality of connection terminals 17a and 17b constituting the second terminal row 17 are provided to protrude forward in parallel to each other in a rectangular flat plate shape in a state of penetrating the sleeve portions 14a and 14b. The plurality of connection terminals 17a and 17b constituting the second terminal row 17 are electrically connected to the device side through an opening 300b provided in the unit 300 in a state where the housing 11 is fixed to the unit 300 side.

In the device-side connector 100A of the present embodiment, the first direction Z and the second direction Y are in a positional relationship of intersecting (orthogonal in the present embodiment) each other in plan view with respect to a plane parallel to the first direction Z and the second direction Y (when a YZ plane is viewed from the X-axis direction in the present embodiment).

The plurality of terminal forming portions 12 have a wiring structure that converts the arrangement directions relative to each other between the first terminal row 16 and the second terminal row 17. Specifically, the plurality of terminal forming portions 12 include a terminal forming portion (hereinafter, distinguished as a “first terminal forming portion 12A”) forming the connector terminal 16a and the connection terminal 17a, and a terminal forming portion (hereinafter, distinguished as a “second terminal forming portion 12B”) forming the connector terminal 16b and the connection terminal 17b.

The first terminal forming portion 12A includes a first wiring portion 19a that is arranged between the connector terminal 16a and the connection terminal 17a. The second terminal forming portion 12B includes a second wiring portion 19b that is arranged between the connector terminal 16b and the connection terminal 17b. In the first terminal forming portion 12A and the second terminal forming portion 12B, the arrangement directions relative to each other between the first terminal row 16 and the second terminal row 17 are converted by differing the lengths and bending positions of the first wiring portion 19a and the second wiring portion 19b.

In the device-side connector 100A of the present embodiment having the above constitution, the arrangement directions relative to each other between the first terminal row 16 and the second terminal row 17 described above can be converted into the first direction Z and the second direction Y orthogonal to each other.

In addition, the device-side connector 100A of the present embodiment constitutes a straight-type connector in which the first terminal row 16 and the second terminal row 17 are parallel to each other in a third direction (the front-rear direction in the present embodiment) (hereinafter, referred to as a “third direction X”).

### W/H-side Connector

As illustrated in FIGS. 1, 2, 5, and 6, the mating W/H-side connector 200A includes a male housing 21 to be inserted into the device-side connector 100A, a plurality of (two in the present embodiment) terminal forming portions 22 held by the housing 21, and a plurality of (two in the present embodiment) wire cords 23 electrically connected to the plurality of terminal forming portions 22.

The housing 21 is formed of a synthetic resin molded body. The housing 21 includes a front plug 24 constituting a front side thereof and a rear case 25 constituting a rear side thereof. The housing 21 has a structure in which the front plug 24 and the rear case 25 are integrated with each other by screwing in a state where the plurality of terminal forming portions 22 are housed between the front plug 24 and the rear case 25.

In the present embodiment, four holes 24a are provided at four corners of the front plug 24 so as to penetrate in the front-rear direction. A circular ring-shaped collar 26 is fitted inside each hole 24a. On the other hand, four screw holes 25e corresponding to the four holes 24a are provided on the front side of the rear case 25.

The front plug 24 and the rear case 25 constitute the housing 21 in which the front plug 24 and the rear case 25 are integrated with each other by screwing screws 27 through the holes 24a on the front plug 24 side and through the screw holes 25e on the rear case 25 side.

In addition, an inner packing 28 for waterproofing is provided between the front plug 24 and the rear case 25. The inner packing 28 is disposed in a state of being sandwiched between the front plug 24 and the rear case 25 so as to surround the periphery between the front plug 24 and the rear case 25.

The front plug 24 includes a fitting tubular portion 24b to be fitted to the fitting tubular portion 11b of the device-side connector 100A described above, and a plurality of (two in the present embodiment) contact plugs 24c to be fitted to the plurality of connector terminals 16a and 16b constituting the first terminal row 16.

The fitting tubular portion 24b protrudes in a substantially elongated cylindrical shape forward from the front side of the front plug 24, and opens in a substantially elongated circular shape on the front side of the front plug 24. In addition, the longitudinal direction of the fitting tubular portion 24b coincides with the longitudinal direction (the up-down direction in the present embodiment) of the fitting tubular portion 11b.

A connector packing 29 for waterproofing is provided on the front side of the front plug 24. The connector packing 29 is fitted to the periphery of the fitting tubular portion 24b via a packing holder 30.

The plurality of contact plugs 24c are arranged in the first direction Z and provided to protrude forward in parallel with each other in a cylindrical shape in a state of being located inside the fitting tubular portion 24b.

The rear case 25 includes a housing recess 25a that houses the plurality of terminal forming portions 22 from the front side, and a cord lead-out portion 25b that leads out the plurality of wire cords 23 to the outside of the housing 21.

The housing recess 25a has a partition wall 25c that partitions the periphery of each of the plurality of terminal forming portions 22 housed inside.

The cord lead-out portion 25b includes a plurality of (two in the present embodiment) sleeve portions 25d arranged in the first direction Z. The plurality of sleeve portions 25d are provided to protrude in a substantially elongated cylindrical shape in parallel with each other from one side in the second direction Y of the rear case 25. In addition, the plurality of sleeve portions 25d are connected to each other.

The plurality of terminal forming portions 22 are formed by processing a highly conductive metal plate such as copper into a predetermined shape. In the present embodiment, a long crimp terminal is used as the terminal forming portion 22.

A first end side of the plurality of terminal forming portions 22 is located on a side (the front side in the present embodiment) of the housing 21 to be inserted into the device-side connector 100A, and constitutes a third terminal row 31 in which a plurality of (two in the present embodiment) connector terminals 31a and 31b are arranged in the first direction Z.

A second end side of the plurality of terminal forming portions 22 is located on a side (one side in the second direction Y in the present embodiment) different from the side of the housing 21 on which the third terminal row 31 is provided, and constitutes a fourth terminal row 32 in which a plurality of (two in the present embodiment) connection terminals 32a and 32b are arranged in the first direction Z.

The plurality of terminal forming portions 22 include a terminal forming portion (hereinafter, distinguished as a “third terminal forming portion 22A”) forming the connector terminal 31a and the connection terminal 32a, and a terminal forming portion (hereinafter, distinguished as a “fourth terminal forming portion 22B”) forming the connector terminal 31b and the connection terminal 32b.

The third terminal forming portion 22A is bent at a right angle between the connector terminal 31a and the connection terminal 32a. The fourth terminal forming portion 22B is bent at a right angle between the connector terminal 31b and the connection terminal 32b.

The plurality of connector terminals 31a and 31b constituting the third terminal row 31 are arranged in parallel in the first direction Z and provided to protrude forward in a cylindrical shape. Each of the connector terminals 31a and 31b is fitted inside each contact plug 24c. In addition, a coil-shaped terminal spring 33 is disposed inside each contact plug 24c.

The plurality of connection terminals 32a and 32b constituting the fourth terminal row 32 are arranged in parallel in the first direction Z and provided to protrude in a rectangular flat plate shape toward one side in the second direction Y. Each of the connection terminals 32a and 32b is housed inside each partition wall 25c of the housing recess 25a.

The plurality of wire cords 23 has a constitution in which an electric wire such as copper is covered with an insulating resin, for example. An LA terminal 34 is attached to a first end side of each wire cord 23.

The LA terminals 34 of the plurality of wire cords 23 and the plurality of connection terminals 32a and 32b constituting the fourth terminal row 32 are fixed to the rear case 25 in a state of being joined to each other by screwing screws 35 into the screw holes 25e provided inside the housing recess 25a of the rear case 25 through holes 34a and 32d provided on the respective tip end sides.

A second end side of the wire cord 23 is extended to the outside of the housing 21 through the sleeve portion 25d of the cord lead-out portion. A wire packing 36 for waterproofing is fitted to the tip end side of the sleeve portion 25d via a pair of packing holders 37.

In the W/H-side connector 200A having the above constitution, the arrangement direction of the third terminal row 31 and the arrangement direction of the fourth terminal row 32 are the first direction Z parallel to each other. In addition, the W/H-side connector 200A constitutes an L-shaped connector in which respective orientations of the third terminal row 31 and the fourth terminal row 32 are the third direction X and the second direction Y and orthogonal to each other.

### Lever Lock Mechanism

In the connector structure of the present embodiment, the device-side connector 100A and the W/H-side connector 200A are lever-lock type connectors, and include a lever lock mechanism 50 to which the housings 11 and 21 are fixed in a state of being fitted to each other.

As illustrated in FIGS. 1 to 6, the lever lock mechanism 50 includes a lever 51 provided in any one connector (the W/H-side connector 200A in the present embodiment) of the device-side connector 100A and the W/H-side connector 200A, and a lock pin 52 provided in the other connector (the device-side connector 100A in the present embodiment).

The lever 51 is rotatably attached via a pair of hinges 51a provided on both sides in the first direction Z of the housing 21 (rear case 25). A pair of guide slits 51b are provided on both sides in the first direction Z of the lever 51. The pair of guide slits 51b are cut out in an arc shape from one side in the rotation direction of the lever 51.

The lock pin 52 is provided to protrude from both sides in the first direction Z of the housing 11. A flange portion 52a protruding in the radial expansion direction over the entire circumference is provided on the tip end side of the lock pin 52.

In the lever lock mechanism 50, by rotating the lever 51 in a lock direction in a state where the housings 11 and 21 are fitted to each other, the pair of lock pins 52 are guided to the ends of the pair of guide slits 51b in a state of being engaged with the pair of guide slits 51b. Further, by rotating the lever 51 to a lock position, the housings 11 and 21 are fixed in a state of being biased in a direction in which the housings 11 and 21 are fitted to each other. The W/H-side connector 200A can be attached to the device-side connector 100A by the attaching operation of the lever lock mechanism 50.

On the other hand, in the lever lock mechanism 50, the pair of lock pins 52 are guided to the opening ends of the pair of guide slits 51b by rotating the lever from the lock position in an unlocking direction. Further, by rotating the lever 51 to a lock release position, the engagement state between the pair of lock pins 52 and the pair of guide slits 51b is released. By the detaching operation of the lever lock mechanism 50, the state where the housings 11 and 21 are fitted to each other can be released, and the W/H-side connector 200A can be detached from the device-side connector 100A.

### Interlock Mechanism

In the connector structure of the present embodiment, as illustrated in FIGS. 1 to 6, the device-side connector 100A and the W/H-side connector 200A include an interlock mechanism 60 that makes a state of enabling energization between the housings 11 and 21 by detecting a state where the housings 11 and 21 are fitted to each other.

The interlock mechanism 60 includes an interlock housing 61 provided on the device-side connector 100A side and a wire cord 62 for a detection circuit, and a short terminal 63 and a detection circuit element 64 provided on the W/H-side connector 200A side.

The interlock housing 61 is attached via a spacer 65 to an attachment hole 11f provided between the sleeve portions 14a and 14b from the front side of the front plug 24 (housing 11) in a state of holding a signal terminal 62a provided at the tip end of the wire cord 62 for the detection circuit.

The short terminal 63 is fitted inside a contact plug 24d for a detection circuit provided inside the fitting tubular portion 24b of the front plug 24.

The detection circuit element 64 is a connector position assurance (CPA) device that ensures that the connectors 100A and 200A are fitted to each other up to a regular position. The detection circuit element 64 is attached to the rear side of the rear case 25 (housing 11).

In the interlock mechanism 60, in a state where the connectors 100A and 200A are fitted to each other by the lever lock mechanism 50 described above, energization is not performed between the connectors 100A and 200A unless the signal terminal 62a on the device-side connector 100A side comes into contact with the detection circuit element 64. With this constitution, it is possible to ensure that the connectors 100A and 200A are fitted to each other up to a regular position.

### Connector Structure

In the connector structure of the present embodiment, in a state where the housing 11 of the device-side connector 100A and the housing 21 of the W/H-side connector 200A described above are fitted to each other, the fitting tubular portion 11b of the housing 11 and the fitting tubular portion 24b of the housing 21 are fitted to each other. In addition, the plurality of connector terminals 16a and 16b constituting the first terminal row 16 are fitted to the plurality of contact plugs 24c of the housing 21, so that the plurality of connector terminals 16a and 16b constituting the first terminal row 16 and the plurality of connector terminals 31a and 31b constituting the third terminal row 31 are electrically connected to each other.

In addition, in the connector structure of the present embodiment, in a state where the housing 11 of the device-side connector 100A and the housing 21 of the W/H-side connector 200A are fitted to each other, the arrangement direction of the second terminal rows 17 on the device side is the second direction Y, whereas the arrangement direction of the wire cords 23 on the W/H side is the first direction Z orthogonal to the second direction Y.

As described above, in the device-side connector 100A of the present embodiment, by converting the arrangement directions relative to each other between the first terminal row 16 and the second terminal row 17 described above into the first direction Z and the second direction Y orthogonal to each other, it is possible to increase the degrees of freedom in the arrangement directions of the first terminal row 16 and the second terminal row 17.

Note that, as illustrated in FIG. 7, the device-side connector 100A has a constitution in which the signal terminal 62a of the interlock mechanism 60 is located on one side of the plurality of connector terminals 16a and 16b arranged in the first direction Z, and the signal terminal 62a of the interlock mechanism 60 is located between the plurality of connection terminals 17a and 17b arranged in the second direction Y.

On the other hand, in the device-side connector 100A, as illustrated in FIG. 8A, the signal terminal 62a of the interlock mechanism 60 may be located between the plurality of connector terminals 16a and 16b arranged in the first direction Z, and the signal terminal 62a of the interlock mechanism 60 may be located between the plurality of connection terminals 17a and 17b arranged in the second direction Y.

On the other hand, in the device-side connector 100A, as illustrated in FIG. 8B, the signal terminal 62a of the interlock mechanism 60 may be located on one side of the plurality of connector terminals 16a and 16b arranged in the first direction Z, and the signal terminal 62a of the interlock mechanism 60 may be located on one side of the plurality of connection terminals 17a and 17b arranged in the second direction Y.

Note that in the first embodiment, the device-side connector 100A and the W/H-side connector 200A have a two-terminal structure. However, a three-terminal structure is also possible, and the number of terminals is not particularly limited.

### SECOND EMBODIMENT

### Connector Structure

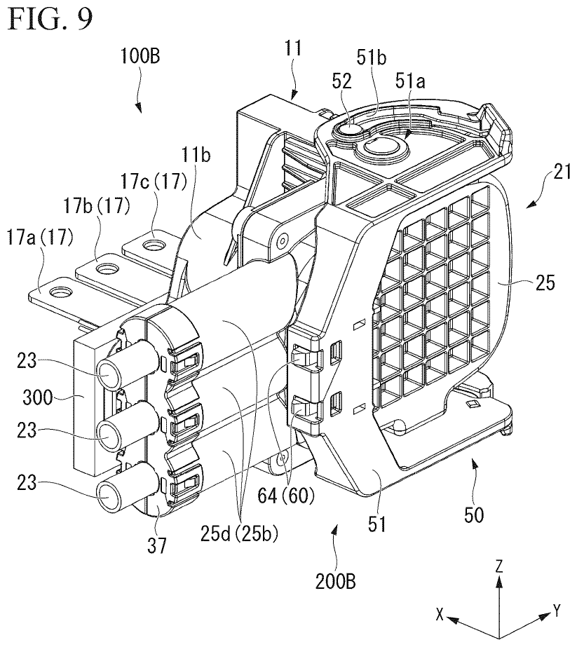

As a second embodiment of the present invention, for example, a connector structure of a W/H-side connector 200B and a mating device-side connector 100B of the present embodiment illustrated in FIGS. 9 to 16 will be described.

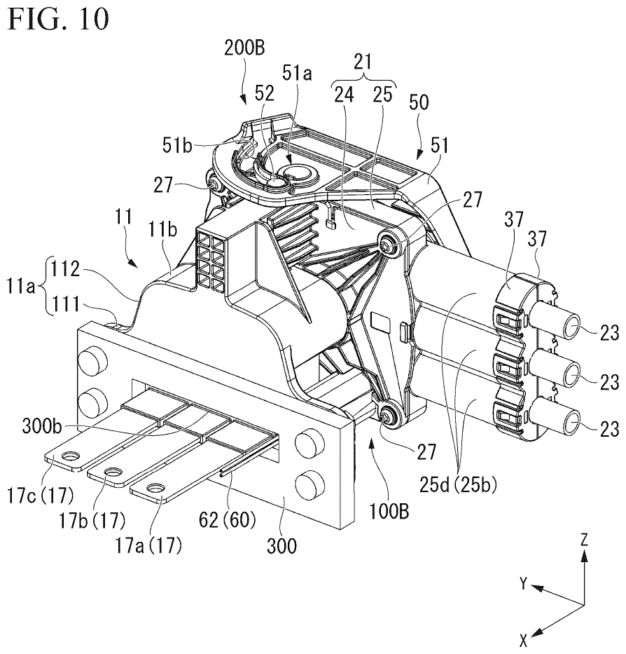

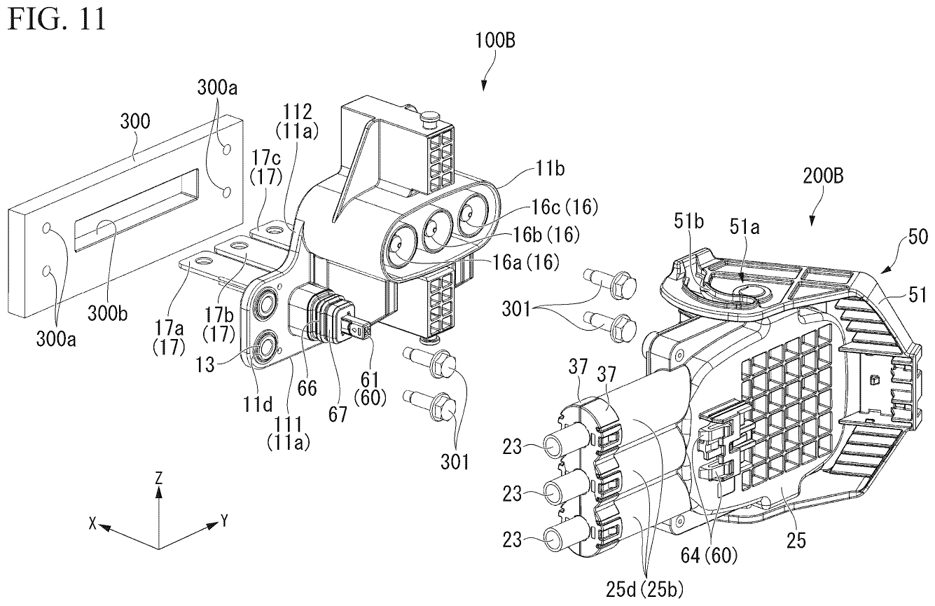

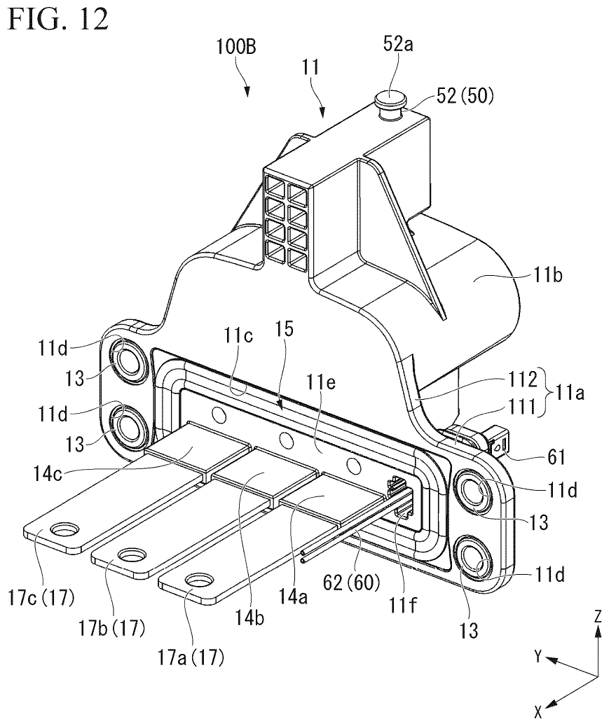

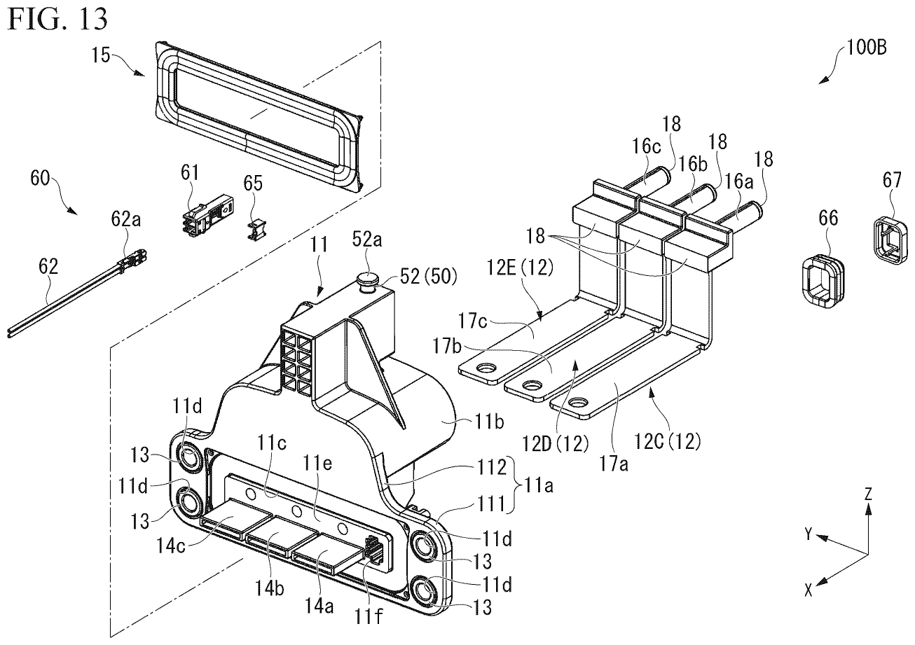

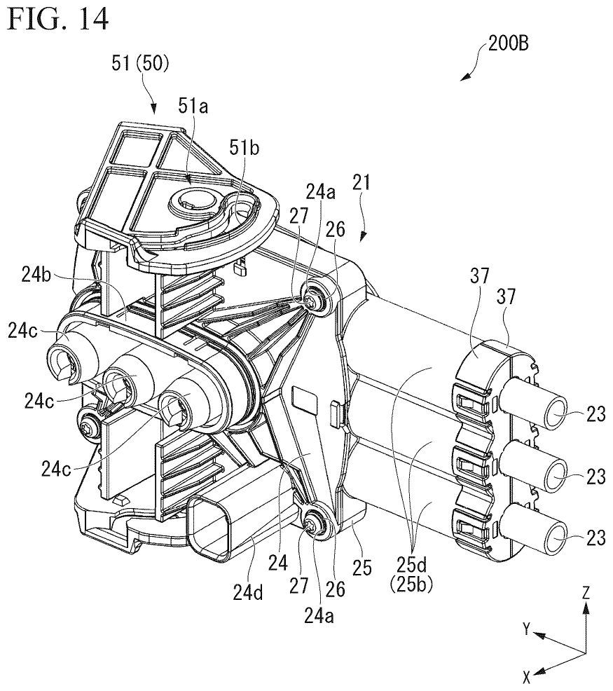

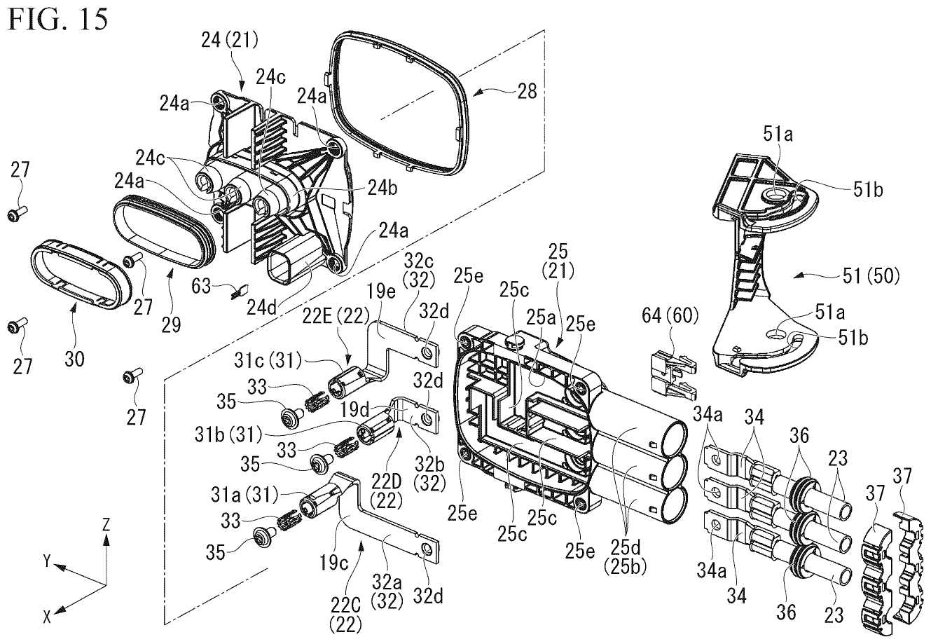

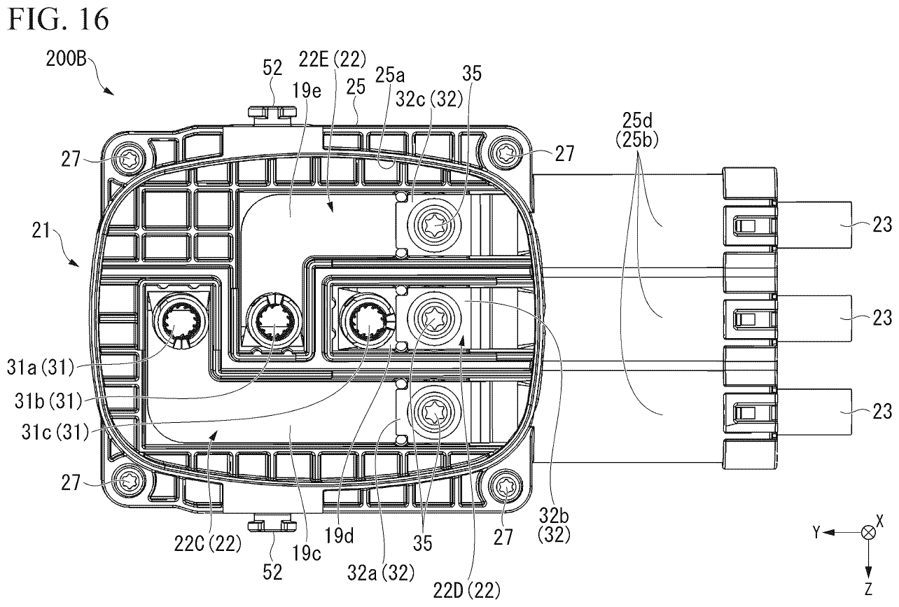

Note that FIG. 9 is a perspective view of a state where the device-side connector 100B and the W/H-side connector 200B are fitted to each other as viewed from the rear side. FIG. 10 is a perspective view of a state where the device-side connector 100B and the W/H-side connector 200B are fitted to each other as viewed from the front side. FIG. 11 is a perspective view illustrating a state before the device-side connector 100B and the W/H-side connector 200B are fitted to each other. FIG. 12 is a perspective view illustrating a constitution of the device-side connector 100B. FIG. 13 is an exploded perspective view illustrating the constitution of the device-side connector 100B. FIG. 14 is a perspective view illustrating a constitution of the W/H-side connector 200B. FIG. 15 is an exploded perspective view illustrating the constitution of the W/H-side connector 200B. FIG. 16 is a front view of the W/H-side connector 200B. In addition, in the following description, the same reference numbers in the drawings denote the same portions as those of the device-side connector 100A and the W/H-side connector 200A.

As illustrated in FIGS. 9, 10, and 11, the connector structure of the present embodiment electrically connects the W/H-side connector 200B and the mating device-side connector 100B of the present embodiment by fitting of the W/H-side connector 200B and the mating device-side connector 100B, and enables energization between the connectors 100B and 200B.

The mating device-side connector 100B constitutes a female (receptacle)-side connector. On the other hand, the W/H-side connector 200B of the present embodiment constitutes a male (plug)-side connector. Therefore, the connector structure of the present embodiment has a structure in which the device-side connector 100B and the W/H-side connector 200B are fitted by inserting the W/H-side connector 200B into the device-side connector 100B.

Note that in the present embodiment, one direction in which the W/H-side connector 200B is inserted into the device-side connector 100B is defined as a front (+X direction) of each of the connectors 100B and 200B, a direction opposite thereto is defined as a rear (−X direction), a side facing the one direction is defined as a front side of each of the connectors 100B and 200B, and a side opposite thereto is defined as a rear side of each of the connectors 100B and 200B.

### Device-Side Connector

As illustrated in FIGS. 9 to 13, the device-side connector 100B includes a female housing 11 into which the W/H-side connector 200B is inserted, and a plurality of (three in the present embodiment) terminal forming portions 12 held by the housing 11.

The housing 11 is formed of a synthetic resin molded body. The housing 11 has a front wall 11a constituting a front side thereof and a fitting tubular portion 11b constituting a rear side thereof. The housing 11 has a structure in which the front wall 11a and the fitting tubular portion 11b are integrated with each other in a state where the plurality of terminal forming portions 12 are sandwiched between the front wall 11a and the fitting tubular portion 11b.

The front wall 11a is a portion that abuts against a unit 300 on a device side. The front wall 11a has a shape in which a lower plate portion 111 having a substantially rectangular flat plate shape with rounded corner portions and an upper plate portion 112 having a substantially triangular flat plate shape with rounded top portions are integrated in the up-down direction. In addition, the longitudinal direction of the lower plate portion 111 coincides with the width direction of the housing 11.

A substantially rectangular opening 11c is provided at the center of the lower plate portion 111 in the width direction. Two upper and lower holes 11d are provided on both sides in the width direction of the lower plate portion 111 with an opening 11c interposed therebetween, so as to penetrate in the front-rear direction. A circular ring-shaped collar 13 is fitted inside each hole 11d.

In the device-side connector 100B of the present embodiment, the housing 11 can be fixed to the unit 300 side by screwing a screw 301 into a screw hole 300a provided on the unit 300 side through each hole 11d.

The fitting tubular portion 11b is a portion into which a housing 21 of the W/H-side connector 200B described later is inserted. The fitting tubular portion 11b protrudes in a substantially elongated cylindrical shape rearward from the rear side of the front wall 11a, and opens in a substantially elongated circular shape on the rear side of the housing 11. In addition, the longitudinal direction of the fitting tubular portion 11b coincides with the up-down direction of the housing 11.

In addition, a fitting protrusion 11e having a shape corresponding to the opening 11c of the front wall 11a and fitted inside the opening 11c is provided on the front side of the fitting tubular portion 11b. Furthermore, on the front side of the fitting protrusion 11e, a plurality of (three in the present embodiment) sleeve portions 14a, 14b, and 14c arranged in parallel in the second direction Y (the left-right direction in the present embodiment) and protruding forward in a flat tubular shape are provided.

A unit packing 15 for waterproofing is provided on the front side of the front wall 11a. The unit packing 15 is fitted inside the opening 11c so as to surround the periphery of the plurality of sleeve portions 14a, 14b, and 14c.

The plurality of terminal forming portions 12 are formed by processing a highly conductive metal plate such as copper into a predetermined shape. In the present embodiment, a bus bar obtained by bending a long metal plate is used as the terminal forming portion 12.

A first end side of the plurality of terminal forming portions 12 is located on a side (the rear side in the present embodiment) of the housing 11 to which the W/H-side connector 200B is inserted, and constitutes a first terminal row 16 in which a plurality of (three in the present embodiment) connector terminals 16a, 16b, and 16c are arranged in the second direction Y.

A second end side of the plurality of terminal forming portions 12 is located on a side (the front side in the present embodiment) different from the side of the housing 11 on which the first terminal row 16 is provided, and constitutes a second terminal row 17 in which a plurality of (three in the present embodiment) connection terminals 17a, 17b, and 17c are arranged in the second direction Y.

The plurality of connector terminals 16a, 16b, and 16c constituting the first terminal row 16 are provided to protrude rearward in parallel to each other in a cylindrical shape in a state of being located inside the fitting tubular portion 11b. In addition, each of the connector terminals 16a, 16b, and 16c is integrally provided with a resin cap 18 that covers the outside on a base end side and penetrates the inside from the base end side toward a tip end side.

The plurality of connection terminals 17a, 17b, and 17c constituting the second terminal row 17 are provided to protrude forward in parallel to each other in a rectangular flat plate shape in a state of penetrating the sleeve portions 14a, 14b, and 14c. The plurality of connection terminals 17a, 17b, and 17c constituting the second terminal row 17 are electrically connected to the device side through an opening 300b provided in the unit 300 in a state where the housing 11 is fixed to the unit 300 side.

The plurality of terminal forming portions 12 include a terminal forming portion (hereinafter, distinguished as a “first terminal forming portion 12C”) forming the connector terminal 16a and the connection terminal 17a, a terminal forming portion (hereinafter, distinguished as a “second terminal forming portion 12D”) forming the connector terminal 16b and the connection terminal 17b, and a terminal forming portion (hereinafter, distinguished as a “third terminal forming portion 12E”) forming the connector terminal 16c and the connection terminal 17c.

The first terminal forming portion 12C is bent in a crank shape between the connector terminal 16a and the connection terminal 17a. The second terminal forming portion 12D is bent in a crank shape between the connector terminal 16b and the connection terminal 17b. The third terminal forming portion 12E is bent in a crank shape between the connector terminal 16c and the connection terminal 17c.

In the device-side connector 100B of the present embodiment having the above constitution, the arrangement direction of the first terminal rows 16 and the arrangement direction of the second terminal rows 17 described above are the second direction Y parallel to each other. In addition, the device-side connector 100B of the present embodiment constitutes a straight-type connector in which the first terminal row 16 and the second terminal row 17 are parallel to each other in the third direction X.

### W/H-side Connector

As illustrated in FIGS. 9 to 11 and 14 to 16, the mating W/H-side connector 200B includes a male housing 21 to be inserted into the device-side connector 100A, a plurality of (three in the present embodiment) terminal forming portions 22 held by the housing 21, and a plurality of (three in the present embodiment) wire cords 23 electrically connected to the plurality of terminal forming portions 22.

The housing 21 is formed of a synthetic resin molded body. The housing 21 includes a front plug 24 constituting a front side thereof and a rear case 25 constituting a rear side thereof. The housing 21 has a structure in which the front plug 24 and the rear case 25 are integrated with each other by screwing in a state where the plurality of terminal forming portions 22 are housed between the front plug 24 and the rear case 25.

In the present embodiment, four holes 24a are provided at four corners of the front plug 24 so as to penetrate in the front-rear direction. A circular ring-shaped collar 26 is fitted inside each hole 24a. On the other hand, four screw holes 25e corresponding to the four holes 24a are provided on the front side of the rear case 25.

The front plug 24 and the rear case 25 constitute the housing 21 in which the front plug 24 and the rear case 25 are integrated with each other by screwing screws 27 through the holes 24a on the front plug 24 side and through the screw holes 25e on the rear case 25 side.

In addition, an inner packing 28 for waterproofing is provided between the front plug 24 and the rear case 25. The inner packing 28 is disposed in a state of being sandwiched between the front plug 24 and the rear case 25 so as to surround the periphery between the front plug 24 and the rear case 25.

The front plug 24 includes a fitting tubular portion 24b to be fitted to the fitting tubular portion 11b of the device-side connector 100A described above, and a plurality of (three in the present embodiment) contact plugs 24c to be fitted to the plurality of connector terminals 16a and 16b constituting the first terminal row 16.

The fitting tubular portion 24b protrudes in a substantially elongated cylindrical shape forward from the front side of the front plug 24, and opens in a substantially elongated circular shape on the front side of the front plug 24. In addition, the longitudinal direction of the fitting tubular portion 24b coincides with the longitudinal direction (the left-right direction in the present embodiment) of the fitting tubular portion 11b.

A connector packing 29 for waterproofing is provided on the front side of the front plug 24. The connector packing 29 is fitted to the periphery of the fitting tubular portion 24b via a packing holder 30.

The plurality of contact plugs 24c are arranged in the second direction Y and provided to protrude forward in parallel with each other in a cylindrical shape in a state of being located inside the fitting tubular portion 24b.

The rear case 25 includes a housing recess 25a that houses the plurality of terminal forming portions 22 from the front side, and a cord lead-out portion 25b that leads out the plurality of wire cords 23 to the outside of the housing 21.

The housing recess 25a has a partition wall 25c that partitions the periphery of each of the plurality of terminal forming portions 22 housed inside.

The cord lead-out portion 25b includes a plurality of (three in the present embodiment) sleeve portions 25d arranged in the first direction Z (the up-down direction in the present embodiment). The plurality of sleeve portions 25d are provided to protrude in a substantially elongated cylindrical shape in parallel with each other from one side in the second direction Y of the rear case 25. In addition, the plurality of sleeve portions 25d are connected to each other.

The plurality of terminal forming portions 22 are formed by processing a highly conductive metal plate such as copper into a predetermined shape. In the present embodiment, a long crimp terminal is used as the terminal forming portion 22.

A first end side of the plurality of terminal forming portions 22 is located on a side (the front side in the present embodiment) of the housing 21 to be inserted into the device-side connector 100A, and constitutes a third terminal row 31 in which a plurality of (three in the present embodiment) connector terminals 31a, 31b, and 31c are arranged in the first direction Z.

A second end side of the plurality of terminal forming portions 22 is located on a side (one side in the second direction Y in the present embodiment) different from the side of the housing 21 on which the third terminal row 31 is provided, and constitutes a fourth terminal row 32 in which a plurality of (three in the present embodiment) connection terminals 32a, 32b, and 32c are arranged in the first direction Z.

The plurality of terminal forming portions 22 have a wiring structure that converts the arrangement directions relative to each other between the third terminal row 31 and the fourth terminal row 32. Specifically, the plurality of terminal forming portions 22 include a terminal forming portion (hereinafter, distinguished as a “fourth terminal forming portion 22C”) forming the connector terminal 31a and the connection terminal 32a, a terminal forming portion (hereinafter, distinguished as a “fifth terminal forming portion 22D”) forming the connector terminal 31b and the connection terminal 32b, and a terminal forming portion (hereinafter, distinguished as a “sixth terminal forming portion 22E”) forming the connector terminal 31c and the connection terminal 32c.

The fourth terminal forming portion 22C includes a first wiring portion 19c that is arranged between the connector terminal 31a and the connection terminal 32a. The fifth terminal forming portion 22D includes a second wiring portion 19d that is arranged between the connector terminal 31b and the connection terminal 32b. The sixth terminal forming portion 22E includes a third wiring portion 19e that is arranged between the connector terminal 31c and the connection terminal 32c. In the fourth terminal forming portion 22C, the fifth terminal forming portion 22D, and the sixth terminal forming portion 22E, the arrangement directions relative to each other between the third terminal row 31 and the fourth terminal row 32 are converted by differing the lengths and bending positions of the first wiring portion 19c, the second wiring portion 19d, and the third wiring portion 19e.

The plurality of connector terminals 31a, 31b, and 31c constituting the third terminal row 31 are arranged in parallel in the second direction Y and provided to protrude forward in a cylindrical shape. Each of the connector terminals 31a, 31b, and 31c is fitted inside each contact plug 24c. In addition, a coil-shaped terminal spring 33 is disposed inside each contact plug 24c.

The plurality of connection terminals 32a, 32b, and 32c constituting the fourth terminal row 32 are arranged in parallel in the first direction Z and provided to protrude in a rectangular flat plate shape toward one side in the second direction Y. Each of the connection terminals 32a, 32b, and 32c is housed inside each partition wall 25c of the housing recess 25a.

The plurality of wire cords 23 has a constitution in which an electric wire such as copper is covered with an insulating resin, for example. An LA terminal 34 is attached to a first end side of each wire cord 23.

The LA terminals 34 of the plurality of wire cords 23 and the plurality of connection terminals 32a, 32b, and 32c constituting the fourth terminal row 32 are fixed to the rear case 25 in a state of being joined to each other by screwing screws 35 into the screw holes 25e provided inside the housing recess 25a of the rear case 25 through holes 34a and 32d provided on the respective tip end sides.

A second end side of the wire cord 23 is extended to the outside of the housing 21 through the sleeve portion 25d of the cord lead-out portion. A wire packing 36 for waterproofing is fitted to the tip end side of the sleeve portion 25d via a pair of packing holders 37.

In the W/H-side connector 200B having the above constitution, the arrangement directions relative to each other between the third terminal row 31 and the fourth terminal row 32 described above can be converted into the second direction Y and the first direction Z orthogonal to each other.

In addition, the W/H-side connector 200B of the present embodiment constitutes an L-shaped connector in which respective orientations of the third terminal row 31 and the fourth terminal row 32 are the third direction X and the second direction Y and orthogonal to each other.

### Lever Lock Mechanism

In the connector structure of the present embodiment, as illustrated in FIGS. 9 to 16, the device-side connector 100A and the W/H-side connector 200A are lever-lock type connectors, and include a lever lock mechanism 50 to which the housings 11 and 21 are fixed in a state of being fitted to each other. Note that description of the constitution of the lever lock mechanism 50 will be omitted.

In the lever lock mechanism 50, by rotating the lever 51 in a lock direction in a state where the housings 11 and 21 are fitted to each other, the pair of lock pins 52 are guided to the ends of the pair of guide slits 51b in a state of being engaged with the pair of guide slits 51b. Further, by rotating the lever 51 to a lock position, the housings 11 and 21 are fixed in a state of being biased in a direction in which they are fitted to each other. The W/H-side connector 200B can be attached to the device-side connector 100B by the attaching operation of the lever lock mechanism 50.

On the other hand, in the lever lock mechanism 50, the pair of lock pins 52 are guided to the opening ends of the pair of guide slits 51b by rotating the lever from the lock position in an unlocking direction. Further, by rotating the lever 51 to a lock release position, the engagement state between the pair of lock pins 52 and the pair of guide slits 51b is released. By the detaching operation of the lever lock mechanism 50, the state where the housings 11 and 21 are fitted to each other can be released, and the W/H-side connector 200B can be detached from the device-side connector 100B.

### Interlock Mechanism

In the connector structure of the present embodiment, as illustrated in FIGS. 9 to 16, the device-side connector 100A and the W/H-side connector 200A include an interlock mechanism 60 that makes a state of enabling energization between the housings 11 and 21 by detecting a state where the housings 11 and 21 are fitted to each other. Note that description of the constitution of the interlock mechanism 60 will be omitted.

An interlock packing 66 for waterproofing is provided on the rear side of the rear case 25 (housing 11). The interlock packing 66 is fitted into the attachment hole 11f via a packing holder 67. On the other hand, the interlock housing 61 is provided to protrude rearward from the rear side of the rear case 25 (housing 11) in a state of penetrating the interlock packing 66 and the packing holder 67.

In the interlock mechanism 60, in a state where the connectors 100B and 200B are fitted to each other by the lever lock mechanism 50 described above, energization is not performed between the connectors 100B and 200B unless the signal terminal 62a on the device-side connector 100B side comes into contact with the detection circuit element 64. With this constitution, it is possible to ensure that the connectors 100B and 200B are fitted to each other up to a regular position.

### Connector Structure

In the connector structure of the present embodiment, in a state where the housing 11 of the device-side connector 100B and the housing 21 of the W/H-side connector 200B described above are fitted to each other, the fitting tubular portion 11b of the housing 11 and the fitting tubular portion 24b of the housing 21 are fitted to each other. In addition, the plurality of connector terminals 16a, 16b, and 16c constituting the first terminal row 16 are fitted to the plurality of contact plugs 24c of the housing 21, so that the plurality of connector terminals 16a, 16b, and 16c constituting the first terminal row 16 and the plurality of connector terminals 31a, 31b, and 31c constituting the third terminal row 31 are electrically connected to each other.

In addition, in the connector structure of the present embodiment, as illustrated in the drawing, in a state where the housing 11 of the device-side connector 100B and the housing 21 of the W/H-side connector 200B are fitted to each other, the arrangement direction of the second terminal rows 17 on the device side is the second direction Y, whereas the arrangement direction of the wire cords 23 on the W/H side is the first direction Z orthogonal to the second direction Y.

As described above, in the W/H-side connector 200B of the present embodiment, by converting the arrangement directions relative to each other between the third terminal row 31 and the fourth terminal row 32 described above into the first direction Z and the second direction Y orthogonal to each other, it is possible to increase the degrees of freedom in the arrangement directions of the third terminal row 31 and the fourth terminal row 32.

Note that in the second embodiment, the device-side connector 100B and the W/H-side connector 200B have a three-terminal structure. However, a two-terminal structure is also possible, and the number of terminals is not particularly limited.

While preferred embodiments of the invention have been described and illustrated above, it should be understood that these are exemplary examples of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

### BRIEF DESCRIPTION OF THE REFERENCE SYMBOLS

11 housing
12 terminal forming portion
16 first terminal row
16a, 16b, 16c connector terminal
17 second terminal row
17a, 17b, 17c connection terminal
19a first wiring portion
19b second wiring portion
19c first wiring portion
19d second wiring portion
19e third wiring portion
21 housing
22 terminal forming portion
23 wire cord
31 third terminal row
31a, 31b, 31c connector terminal
32 fourth terminal row
32a, 32b, 32c connection terminal
50 lever lock mechanism
60 interlock mechanism
100A, 100B device-side connector
200A, 200B W/H-side connector
300 unit
X third direction
Y second direction
Z first direction

What is claimed is:

1. A connector comprising:
a female housing into which a mating connector is inserted; and
a plurality of terminal forming portions which are held by the housing,
wherein a first end side of the plurality of terminal forming portions is located on a side of the housing to which the mating connector is inserted, and constitutes a first terminal row in which a plurality of connector terminals are arranged in a first direction,
a second end side of the plurality of terminal forming portions is located on a side different from a side of the housing on which the first terminal row is provided, and constitutes a second terminal row in which a plurality of connection terminals are arranged in a second direction, and
the first direction and the second direction are in a positional relationship of intersecting with each other in plan view with respect to a plane parallel to the first direction and the second direction.

2. The connector according to claim 1, wherein
the plurality of terminal forming portions have a wiring structure that converts arrangement directions relative to each other between the first terminal row and the second terminal row.

3. A connector comprising:
a male housing to be inserted into a mating connector; and
a plurality of terminal forming portions which are held by the housing,
wherein a first end side of the plurality of terminal forming portions is located on a side of the housing to be inserted into the mating connector, and constitutes a third terminal row in which a plurality of connector terminals are arranged in a second direction,
a second end side of the plurality of terminal forming portions is located on a side different from a side of the housing on which the third terminal row is provided, and constitutes a fourth terminal row in which a plurality of connection terminals are arranged in a first direction, and
the first direction and the second direction are in a positional relationship of intersecting with each other in plan view with respect to a plane parallel to the first direction and the second direction.

4. The connector according to claim 3, wherein
the plurality of terminal forming portions have a wiring structure that converts arrangement directions relative to each other between the third terminal row and the fourth terminal row.

5. The connector according to claim 1, wherein
the first direction and the second direction are in a positional relationship of being orthogonal to each other in plan view with respect to a plane parallel to the first direction and the second direction.

6. The connector according to claim 1, wherein
the connector is a lever-lock type connector which is fitted to the mating connector by rotation of a lever.

7. The connector according to claim 3, wherein
the first direction and the second direction are in a positional relationship of being orthogonal to each other in plan view with respect to a plane parallel to the first direction and the second direction.

8. The connector according to claim 3, wherein
the connector is a lever-lock type connector which is fitted to the mating connector by rotation of a lever.
